(19) United States
(12) Patent Application Publication
(10) Pub. No.: US 2004/0102354 A1
(43) Pub. Date: May 27, 2004

(54) Cosmetic detergent compositions containing an amphoteric polysaccharide and an insoluble conditioning agent, and use thereof

(76) Inventors: Geraldine Fack, Levallois-Perret (FR); Serge Restle, Saint-Prix (FR); Claude Dubief, Le Chesnay (FR)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/250,888

(22) PCT Filed: Jan. 11, 2002
(86) PCT No.: PCT/FR02/00104

(30) Foreign Application Priority Data
Jan. 12, 2001 (FR) 01/00407

(51) Int. Cl. C11D 1/00

(52) U.S. Cl. 510/466

(57) ABSTRACT

The invention relates to novel hair detergent an conditioning compositions comprising, in a cosmetically acceptable medium, an anionic surfactant, an amphoteric, at least one amphoteric polysaccharide selected from among celluloses, inulins and guar gums and with at least on water-insoluble conditioning agent selected from a) synthetic oils, B0 silicones having a viscosity greater than or equal to 1,000 mm 2/s, polysiloxanes, the general structure thereof comprising one or more organofunctional groups, C) animal or vegetable oils, D) waxes, E) carboxylic acid esters, F) ceramide-type compounds. The inventive compositions are intended for hair care and cleaning.

The present invention relates to novel cosmetic compositions having improved properties, intended for simultaneously cleaning and conditioning hair, and comprising, in a cosmetically acceptable carrier, an anionic surfactant, an amphoteric surfactant, at least one amphoteric polysaccharide, chosen from celluloses, inulins and guar gums, and at least one water-insoluble conditioning agent.

The invention also relates to the use of said compositions in the abovementioned cosmetic application.

The use of detergent hair compositions (or shampoos) based essentially on conventional surfactants especially of the anionic, nonionic and/or amphoteric type, but more particularly of the anionic type, is common for cleaning and/or washing the hair. These compositions are applied to wet hair and the foam generated by massaging or rubbing with the hands allows, after rinsing with water, the removal of the various types of dirt initially present on the hair.

These base compositions indeed possess good washing power, but the intrinsic cosmetic properties attached to them remain nevertheless fairly weak, in particular because of the fact that the relatively aggressive nature of such a cleaning treatment can cause in the long term damage to the hair fiber which is marked to a greater or lesser degree, linked in particular to the gradual removal of the lipids or proteins contained in or at the surface thereof.

Consequently, to improve the cosmetic properties of the above detergent compositions, and more particularly of those which are intended to be applied to sensitive hair (i.e. hair which has become damaged or which has been made fragile especially under the chemical action of atmospheric agents and/or of hair treatments such as permanent waving, dyeing or bleaching) it is now customary to introduce therein additional cosmetic agents called conditioning agents, intended mainly to repair or limit the harmful or undesirable effects induced by the various treatments or attacks to which the hair fibers are subjected more or less repeatedly. These conditioning agents can of course also improve the cosmetic behavior of natural hair.

The conditioning agents most commonly used to date in shampoos are cationic polymers, silicones and/or silicone derivatives which indeed confer on washed, dry or wet hair greatly improved ease of disentanglement and softness compared to what may be obtained with the corresponding cleaning compositions not containing them. However, the abovementioned cosmetic advantages are unfortunately also accompanied, on dry hair, by certain cosmetic effects which are judged undesirable, namely an increase in the weight of the hair and a lack of sleekness.

Moreover, the use of cationic polymers with this aim in mind has various disadvantages. Because of their high affinity for the hair, some of these polymers become substantially deposited during repeated use, and lead to undesirable effects such as a charged, unpleasant feel, stiffening of the hair, and interfiber adhesion affecting hair styling. These disadvantages are increased in the case of fine hair, which lacks vitality and volume.

In short, it is found that current cosmetic compositions containing conditioning agents are not completely satisfactory.

On sensitized hair, in order to obtain the cosmetic effects of silicones on the entire length of the hair fiber, combinations of silicones and cationic polymers are preferably used.

However, and in spite of the progress recently made in the field of shampoos based on cationic polymers and silicones, they are not truly completely satisfactory, such that a great need currently still exists in relation to being able to have novel products exhibiting better performance in terms of one or more of the cosmetic properties mentioned above.

The present invention aims to satisfy such a need.

Accordingly, following major research studies carried out on the subjects, it has now been found by the Applicant, completely unexpectedly and surprisingly, that by using a particular washing base, namely a washing base combining at least one anionic-type surfactant and at least one amphoteric surfactant, additionally simultaneously comprising at least one suitably selected conditioning agent, as defined below, and particular amphoteric polysaccharides, it is possible to obtain detergent compositions exhibiting excellent cosmetic properties, in particular in terms of ease of hair styling, of retention, of vitality, of sleekness and of softness of the treated hair, and a very good intrinsic washing power.

All these discoveries form the basis of the present invention.

Accordingly, according to the present invention, novel compositions, in particular detergent and conditioning hair compositions, are now provided which comprise, in a cosmetically acceptable medium, at least one anionic surfactant, at least one amphoteric surfactant, at least one amphoteric polysaccharide chosen from celluloses, inulins and guar gums, and at least one water-insoluble conditioning agent chosen from:

A) synthetic oils,

B) silicones chosen from:

(i) polyalkylsiloxanes, polyarylsiloxanes, polyalkylarylsiloxanes, which are linear, branched or cyclic, crosslinked or noncrosslinked, having a viscosity greater than or equal to 1000 mm²/S (1000 cSt),

(ii) polysiloxanes, containing in their general structure one or more organofunctional groups,

C) animal, mineral or vegetable oils,

D) waxes, in particular vegetable waxes,

E) esters chosen from esters of saturated or unsaturated, linear or branched C₁₀-C₃₀ aliphatic mono-, di- and tricarboxylic acids and of saturated or unsaturated, linear or branched C₁-C₈ aliphatic alcohols or polyols, esters of saturated or unsaturated, linear or branched C₂-C₈ aliphatic mono-, di- and tricarboxylic acids and of saturated or unsaturated, linear or branched C₁₀-C₃₀ aliphatic alcohols or polyols,

F) compounds of the ceramide type.

The subject of the invention is also the cosmetic use of the above compositions for cleaning and conditioning hair.

However, other characteristics, features and advantages of the invention will emerge even more clearly on reading the description which follows and the concrete, but not at all limiting, examples intended to illustrate it.

In the context of the present application, conditioning agent is understood to mean any agent which has as function improving the cosmetic properties of hair, in particular the softness, disentanglement, feel and static electricity.

(i) Anionic Surfactant(s):

Their nature is not of truly critical importance within the context of the present invention.

Thus, by way of example of anionic surfactants that can be employed, by themselves or as mixtures, in the context of the present invention, there may be mentioned especially (nonlimiting list) the salts (in particular alkali metal, especially sodium, salts, ammonium salts, amine salts, amino alcohol salts or magnesium salts) of the following compounds: alkyl sulfates, alkyl ether sulfates, alkylamido ether sulfates, alkylarylpolyether sulfates, monoglyceride sulfates, alkyl sulfonates, alkyl phosphates, alkylamidesulfonates, alkyl aryl sulfonates, α-olefinsulfonates, paraffinsulfonates, alkyl sulfosuccinates, alkyl ether sulfosuccinates, alkylamide sulfosuccinates, alkyl sulfosuccinamates, alkyl sulfoacetates, alkyl ether phosphates, acyl sarcosinates, acyl isethionates and N-acyltaurates, the alkyl or acyl radical of all these different compounds preferably containing from 12 to 20 carbon atoms, and the aryl radical preferably denoting a phenyl or benzyl group. Among the anionic surfactants which are further usable there may also be mentioned the salts of fatty acids such as the salts of oleic, ricinoleic, palmitic and stearic acids, the acids of copra oil or of hydrogenated copra oil, and acyl lactylates in which the acyl radical contains 8 to 20 carbon atoms. It is also possible to employ weakly anionic surfactants, like alkyl-D-galactosideuronic acids and salts thereof, as well as the polyoxyalkylenated ether carboxylic acids and salts thereof, in particular those containing from 2 to 50 ethylene oxide groups, and mixtures thereof. The anionic surfactants of the type including polyoxyalkylenated ether carboxylic acids or salts are in particular those corresponding to the following formula (1):

R₁—(OC₂H₄)ₙ—OCH₂COOA (1)

in which:

R₁ denotes an alkyl or alkylaryl group, and n is an integer or a decimal number (mean value) which may range from 2 to 24, and preferably from 3 to 10, the alkyl radical having between 6 and 20 carbon atoms approximately and aryl preferably denoting phenyl,

A denotes H, ammonium, Na, K, Li, Mg or a monoethanolamine or triethanolamine residue. It is also possible to use mixtures of compounds of formula (1), in particular mixtures in which the groups R₁ are different.

Among all these anionic surfactants, the use of salts of alkylsulfates and of alkyl ether sulfates, and mixtures thereof, is more particularly preferred.

(ii) Amphoteric Surfactant(s):

The amphoteric surfactants, the nature of which is not of critical importance in the context of the present invention, may be especially (nonlimiting list) derivatives of aliphatic secondary or tertiary amines in which the aliphatic radical is a linear or branched chain containing 8 to 22 carbon atoms and containing at least one water-solubilizing anionic group (for example carboxylate, sulfonate, sulfate, phosphate or phosphonate); (C₈-C₂₀) alkylbetaines, sulfobetaines, (C₈-C₂₀) alkylamido (C₁-C₆) alkylbetaines or (C₈-C₂₀)alkylamido(C₁-C₆)alkylsulfobetaines may further be mentioned.

Among the amine derivatives there may be mentioned the products sold under the name Miranol, as described in U.S. Pat. No. 2,528,378 and U.S. Pat. No. 2,781,354 and of structures:

R₂—CONHCH₂CH₂—N⁺(R₃)(R₄)(CH₂COO—) (2)

in which: R₂ denotes an alkyl radical derived from an acid R₂—COOH present in hydrolyzed copra oil, a heptyl, nonyl or undecyl radical, R₃ denotes a beta-hydroxyethyl group and R₄ a carboxymethyl group; and

R₅—CONHCH₂CH₂—N(B)(C) (3)

in which:

B represents —CH₂CH₂OX′, C represents —(CH₂)_{z}—Y′, with z=1 or 2,

X′ denotes the group —CH₂CH₂—COOH or a hydrogen atom

Y′ denotes —COOH or the radical —CH₂—CHOH—SO3H

R₅ denotes an alkyl radical of an acid RG-COOH present in copra oil or in hydrolyzed linseed oil, an alkyl radical, especially C₇, C₉, C₁₁ or C₁₃, a C₁₇ alkyl radical and its iso form or an unsaturated radical C₁₇.

These compounds are classified in the CTFA dictionary, 5th edition, 1993, under the names Disodium Cocoamphodiacetate, Disodium Lauroamphodiacetate, Disodium Caprylamphodiacetate, Disodium Capryloamphodiacetate, Disodium Cocoamphodipropionate, Disodium Lauroamphodipropionate, Disodium Caprylamphodipropionate, Disodium Capryloamphodipropionate, Lauroamphodipropionic acid, Cocoamphodipropionic acid.

By way of example, there may be mentioned the cocoamphodiacetate marketed under the trade name MIRANOL C2M concentrate by the company RHODIA CHIMIE.

An anionic surfactant is preferably used which is chosen from sodium, triethanolamine or ammonium (C₁₂-C₁₄)alkyl sulfates, oxyethylenated sodium, triethanolamine or ammonium (C₁₂-C₁₄)alkyl ether sulfates containing 2.2 mol of ethylene oxide, from sodium, triethanolamine or ammonium (C₁₂-C₁₄)alkylamidosulfates, sodium cocoyl isethionate and sodium (C₁₄-C₁₆)alphaolefin sulfonate and their mixtures with:

either an amphoteric surfactant such as the amine derivatives called disodium cocoamphodipropionate or sodium cocoamphopropionate marketed in particular by the company RHODIA CHIMIE under the trade name “MIRANOL C2M CONC” in aqueous solution at 38% of active material or under the name MIRANOL C32;

or an amphoteric surfactant of the zwitterionic type such as the alkylamidobetaines and alkylbetaines, in particular the cocobetaine marketed under the name “DEHYTON AB 30” in aqueous solution at 32% AS by the company COGNIS or such as the (C₈-C₂₀)alkylamido(C₁-C₆)-alkylbetaines, in particular TEGOBETAINE® F 50 marketed by the company GOLDSCHMIDT.

Preferably, the composition does not comprise a surfactant polyurethanebetaine.

As a guide, the detergent compositions in accordance with the invention generally have the following compositions:

(i) anionic surfactant(s): from 2 to 50% by weight, preferably from 3 to 30% by weight, relative to the total weight of the detergent composition, and more particularly 3 to 20% by weight;

(ii) amphoteric surfactant(s): from 1 to 50% by weight, preferably from 1 to 20% by weight, relative to the total weight of the composition, and more particularly 1 to 10% by weight.

The total quantity of detergent surfactants described above is generally greater than or equal to 3% by weight, preferably between 3% and 60% by weight, better still between 4% and 30% by weight, and at best between 4% and 20% by weight relative to the total weight of the composition. The amphoteric surfactant/anionic surfactant weight ratio is preferably between 0.2 and 10, more particularly between 0.25 and 5, and still more particularly between 0.3 and 3.

The amphoteric polysaccharides may be chosen in particular from

polysaccharides grafted with units A and B where A denotes a cationic unit derived from a monomeric or polymeric group containing at least one nitrogen atom belonging to a primary, secondary, tertiary or quaternary amine functional group, and B denotes an anionic unit derived from a monomeric or polymeric group containing one or more carboxylic acid, phosphoric acid, phosphonic acid, sulfate or sulfonic acid functional groups;

polysaccharides grafted with one or more units C, where C denotes a unit derived from a monomeric or polymeric group containing at least one zwitterionic group or carboxybetaines or sulfobetaines;

polysaccharides grafted with one or more units D, where D denotes a unit derived from a monomeric or polymeric group containing at least one anionic group derived from a monomeric or polymeric group containing one or more carboxylic acid, phosphoric acid, phosphonic acid, sulfate or sulfonic acid functional groups and at least one cationic group containing a primary, secondary, tertiary or quaternary amine functional group.

The total degree of substitution of the amphoteric polysaccharides according to the invention is statistically between 0.01 and 3 and represents the ratio of the number of substituted hydroxyls in the repeating unit to the number of elementary monosaccharides constituting the unit.

Preferably, the total degree of substitution is between 0.1 and 2.5, and more particularly between 0.2 and 2.

The polysaccharide has a DS(+)/DS(−), cationic degree of substitution to anionic degree of substitution, ratio between 0.01 and 100, and preferably between 0.02 and 50, and more particularly between 0.2 and 10.

The anionic degree of substitution (DS(−)) of the amphoteric polysaccharides according to the invention represents the ratio of the number of hydroxyls substituted by an anionic group in the repeating unit to the number of elementary monosaccharides constituting the unit.

The cationic degree of substitution (DS(+)) of the amphoteric polysaccharides according to the invention represents the ratio of the number of hydroxyls substituted by a cationic group in the repeating unit to the number of elementary monosaccharides constituting the unit.

The polysaccharides of the invention may be substituted with nonionic groups, in particular C₁-C₂₀ alkyl or hydroxyalkyl, and in particular hydroxyethyl.

The weight-average molecular weight of the polysaccharides according to the invention generally varies between 600 and 100000000.

Such products are described in Patent Applications EP-A-339 372, DE-A-3833658, WO98/14482, EP-A-950393 and in U.S. Pat. No. 3,467,647.

Among these products, there may be mentioned, more particularly, the chlorides of hydroxypropyltrimethylammonium guar, modified with a carboxylmethylpropane group and which are manufactured by the company National Starch.

The concentration of amphoteric polysaccharides according to the invention may vary between 0.0001% and 20% by weight approximately relative to the total weight of the composition, and preferably between 0.001 and 10% approximately, and still more preferably between 0.005 and 3% by weight.

The insoluble compounds in accordance with the invention may be solid, liquid or pasty at room temperature (25° C.) and at atmospheric pressure, and they may in particular be provided in the form of oils, waxes, resins or gums.

The insoluble compounds may be dispersed in the compositions in the form of particles generally having a mean size between 2 nanometres and 100 microns.

The water-insoluble compounds are insoluble in water at a concentration greater than or equal to 0.1% by weight in water at 25° C., that is to say that they do not form a macroscopically transparent isotropic solution.

The silicones are chosen from polyalkylsiloxanes, polyarylsiloxanes, polyalkylarylsiloxanes, linear, branched or cyclic, crosslinked or noncrosslinked silicone gums and resins having a viscosity greater than or equal to 1000 mm²/s (1000 cSt) and polysiloxanes, containing in their general structure one or more organofunctional groups.

The viscosity of the silicones is measured at 25° C. according to the ASTM 445 Annex C standard.

Among the polyalkylsiloxanes, there may be mentioned mainly:

the linear polydimethylsiloxanes with trimethylsilyl end groups, such as for example, and without limitation, the SILBIONE® oils of the 70047 series which are marketed by RHODIA CHIMIE, the SILBIONE® 47 V 500000 oil from RHODIA CHIMIE or some types of VISCASIL from GENERAL ELECTRIC;

the linear polydimethylsiloxanes with hydroxydimethylsilyl end groups such as the oils of the 48 V series from RHODIA CHIMIE.

In this class of polyalkylsiloxanes, there may also be mentioned the polyalkylsiloxanes sold by the company GOLDSCHMIDT under the trade names ABILWAX® 9800 and ABILWAX® 9801 which are poly(C₁-C₂₀ alkyl)siloxanes.

Among the polyalkylarylsiloxanes, there may be mentioned the linear or branched polydimethylmethylphenylsiloxanes or polydimethyldiphenylsiloxanes such as the product DC 556 COSMETIC GRADE FLUID from DOW CORNING.

The silicone gums in accordance with the invention are polyorganosiloxanes having a number-average molecular mass of between 200000 and 5000000, used alone or as a mixture in a solvent. This solvent may be chosen from volatile silicones, polydimethylsiloxane (PDMS) oils, polyphenylmethylsiloxane (PPMS) oils, isoparaffins, polyisobutylenes, methylene chloride, pentane, dodecane, tridecanes or mixtures thereof.

The following compounds may be mentioned for example:

polydimethylsiloxane,

poly[(dimethylsiloxane)/(methylvinylsiloxane)],

poly[(dimethylsiloxane)/(diphenylsiloxane)],

poly[(dimethylsiloxane)/(phenylmethylsiloxane)],

poly[(dimethylsiloxane)/(diphenylsiloxane)/(methylvinylsiloxane)].

The following mixtures may be mentioned for example:

1) the mixtures formed from a polydimethylsiloxane which is hydroxylated at the end of the chain (DIMETHICONOL according to the CTFA nomenclature) and from a cyclic polydimethylsiloxane (CYCLOMETHICONE according to the CTFA nomenclature) such as the product Q21401 sold by the company DOW CORNING;

2) the mixtures formed from a polydimethylsiloxane gum with a cyclic silicone such as the product SF 1214 SILICONE FLUID from GENERAL ELECTRIC which is an SE 30 gum having a molecular weight of 500000, solubilized in SF 1202 SILICONE FLUID (decamethylcyclopentasiloxane);

3) the mixtures of two polydimethylsiloxanes (PDMS) of different viscosity, in particular of a PDMS gum and a PDMS oil such as the products SF 1236 and CF 1241 from GENERAL ELECTRIC. The product SF 1236 is the mixture of an SE 30 oil defined above, having a viscosity of 20 m²/s, and an SF 96 oil having a viscosity of 5.10⁻⁵ m²/s (15% of SE 30 gum and 85% of SF 96 oil). The product CF 1241 is the mixture of an SE 30 gum (33%) and a PDMS (67%) having a viscosity of 10⁻³ m²/s.

The silicone resins in accordance with the invention are preferably crosslinked siloxane systems containing the units: R₂SiO_{2/2}, RSiO_{3/2}, SiO_{4/2}, in which R denotes a hydrocarbon group possessing 1 to 6 carbon atoms or a phenyl group. Among these products, those particularly preferred are those where R denotes a lower (C1-C4) alkyl or phenyl radical.

Among these resins, there may be mentioned the product sold under the name DOW CORNING 593 by DOW CORNING or those sold under the name SILICONE FLUID SS 4267 by GENERAL ELECTRIC and which are dimethyl/trimethylpolysiloxanes.

The polysiloxanes containing in their general structure one or more organofunctional groups are chosen from polysiloxanes containing a) substituted or unsubstituted amine-containing groups; b) (per)fluorinated groups; c) thiol groups; d) carboxylate groups; e) hydroxylated groups; f) alkoxylated groups; g) acyloxyalkyl groups; h) amphoteric groups; i) bisulfite groups; j) hydroxyacylamino groups; k) carboxylic acid groups; 1) sulfonic groups; m) sulfate or thiosulfate groups.

The polysiloxanes containing in their general structure one or more organofunctional groups are in particular polyalkylsiloxanes, polyarylsiloxanes, polyalkylarylsiloxanes as defined above (with no viscosity limitation) and containing one or more organofunctional groups which are directly attached to the siloxane chain or attached via a hydrocarbon radical.

The polysiloxanes with organofunctional groups of the invention are those containing:

a) substituted or unsubstituted amine-containing groups such as the products marketed under the name GP 4 Silicone Fluid or GP 7100 by the company GENESEE or the products marketed under the names Q28220 and DOW CORNING 929 or 939 by the company DOW CORNING. The substituted amine-containing groups are in particular C₁-C₄ aminoalkyl or amino(C₁-C₄)alkylamino(C₁-C₄)alkyl groups. The silicones called amodimethicone and trimethylsilylamodimethicone according to the CTFA name are more particularly used.

There may thus be mentioned:

(a) the polysiloxanes called in the CTFA dictionary “amodimethicone” and corresponding to the formula:

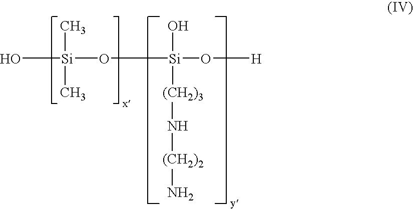

in which x′ and y′ are integers which depend on the molecular weight, generally such that said weight-average molecular weight is between 5000 and 500000 approximately;

(b) the amine-containing silicones corresponding to the formula:

R′ₐG₃₋ₐ—Si(OSiG₂)ₙ—(OSiG_{b}R′_{2-b})ₘ—O—SiG₃₋ₐ—R′ₐ (V)

in which:

G is a hydrogen atom, or a phenyl, OH or C₁-C₈ alkyl group, for example a methyl group,

a denotes the number 0 or an integer from 1 to 3, in particular 0,

b denotes 0 or 1, and in particular 1,

m and n are numbers such that the sum (n+m) may vary in particular from 1 to 2000 and in particular from 50 to 150, it being possible for n to denote a number from 0 to 1999 and in particular from 49 to 149 and it being possible for m to denote a number from 1 to 2000, and in particular from 1 to 10;

R′ is a monovalent radical of formula —C_{q}H_{2q}L in which q is a number from 2 to 8 and L is an optionally quaternized amine-containing group chosen from the groups:

—NR″—CH₂—CH₂N′(R″)₂

—N(R″)₂

—N^{ρ}(R″)₃A⁻

—NH^{ρ}(R″)₂A⁻

—NH₂^{ρ}(R″)A⁻

—N(R″)—CH₂—CH₂—N^{ρ}R″H₂A⁻,

in which R″ may denote hydrogen, phenyl, benzyl, or a monovalent saturated hydrocarbon radical, for example an alkyl radical having from 1 to 20 carbon atoms, and A⁻ represents a halide ion such as, for example, fluoride, chloride, bromide or iodide.

A product corresponding to this definition is the silicone called “trimethylsilylamodimethicone”, corresponding to the formula:

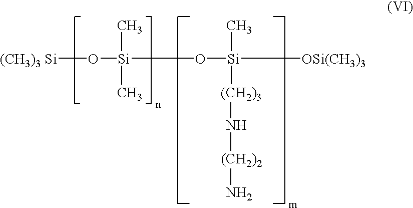

in which n and m have the meanings given above (cf formula V).

Such polymers are described, for example, in Patent Application EP-A-95238.

(c) amine-containing silicones corresponding to the formula:

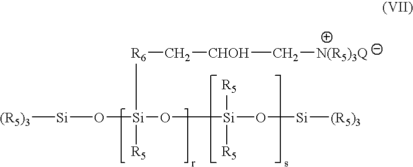

in which

R₅ represents a monovalent hydrocarbon radical having from 1 to 18 carbon atoms, and in particular a C₁-C₁₈ alkyl or C₂-C₁₈ alkenyl radical, for example a methyl radical;

R₆ represents a divalent hydrocarbon radical, in particular a C₁-C₁₈ alkylene radical or a divalent C₁-C₁₈, for example C₁-C₈, alkyleneoxy radical attached to the Si by an SiC bond;

Q⁻ is an anion such as a halide, in particular chloride, ion, or an organic acid salt (acetate, and the like);

r represents a mean statistical value from 2 to 20, and in particular from 2 to 8;

s represents a mean statistical value from 20 to 200, and in particular from 20 to 50.

Such amine-containing silicones are described more particularly in U.S. Pat. No. 4,185,087.

A silicone entering into this class is the silicone marketed by the company Union Carbide under the name “Ucar Silicone ALE 56”.

d) the quaternary ammonium silicones of formula:

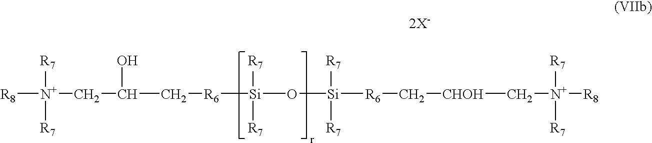

in which

R₇, which are identical or different, represent a monovalent hydrocarbon radical having from 1 to 18 carbon atoms, and in particular a C₁-C₁₈ alkyl radical, a C₂-C₁₈ alkenyl radical or a ring comprising 5 or 6 carbon atoms, for example a methyl radical;

R₆ represents a divalent hydrocarbon radical, in particular a C₁-C₁₈ alkylene radical or a divalent C₁-C₁₈, for example C₁-C₁₈, alkyleneoxy radical attached to the Si by an SiC bond;

R₈, which are identical or different, represent a hydrogen atom, a monovalent hydrocarbon radical having from 1 to 18 carbon atoms, and in particular a C₁-C₁₈ alkyl radical, a C₂-C₁₈ alkenyl radical, a radical —R₆—NHCOR₇;

X⁻ is an anion such as a halide, in particular chloride, ion, or an organic acid salt (acetate, and the like);

r represents a mean statistical value from 2 to 200, and in particular from 5 to 100.

These silicones are, for example, described in Application EP-A-0530974.

Silicones entering into this class are the silicones marketed by the company GOLDSCHMIDT under the names ABIL QUAT 3270, ABIL QUAT 3272, ABIL QUAT 3474.

According to the invention, the amine-containing silicones may be provided in the form of an oil, of aqueous, alcoholic or aqueous-alcoholic solutions, in the form of a dispersion or of an emulsion.

A particularly advantageous embodiment is their use in the form of emulsions, in particular in the form of microemulsions or nanoemulsions.

It is possible to use, for example, the product marketed under the name “Emulsion Cationique DC 929” by the company Dow Corning which comprises, in addition to amodimethicone, a cationic surfactant derived from tallow fatty acids called Tallowtrimonium (CTFA), in combination with a nonionic surfactant known under the name “Nonoxynol 10”.

It is also possible to use, for example, the product marketed under the name “Emulsion Cationique DC 939” by the company Dow Corning, which comprises, in addition to amodimethicone, a cationic surfactant trimethylcetylammonium chloride in combination with a nonionic surfactant trideceth-12.

Another commercial product which can be used according to the invention is the product marketed under the name “Dow Corning Q27224” by the company Dow Corning, containing, in combination, trimethylsilylamodimethicone of formula (IV), a nonionic surfactant of formula: C₈H₁₇—C₆H₄—(OCH₂CH₂)ₙ—OH where n=40, also called octoxynol-40,

another nonionic surfactant of formula:

C₁₂H₂₅—(OCH₂CH₂)ₙ—OH where n=6, also called isolaureth-6, and glycol.

b) (per)fluorinated groups, such as trifluoroalkyl groups such as, for example, those sold by SHIN ETSU under the name FL 100;

c) thiol groups;

d) carboxylate groups, such as the products described in European Patent EP 185 507 from CHISSO CORPORATION;

e) hydroxylated groups, such as the polyorganopolysiloxanes with C₂-C₁₂ hydroxyalkyl functional groups described in French Patent Application FR 85-16334, and in particular polyorganopolysiloxanes with a γ-hydroxypropyl functional group;

f) alkoxylated groups containing at least 12 carbon atoms, such as the product SILICONE COPOLYMER F755 from SWS SILICONES and the products ABILWAX® 2428 ABILWAX® 2434, ABILWAX® 2440 from the company GOLDSCHMIDT;

g) acyloxyalkyl groups containing at least 12 carbon atoms, such as polyorganosiloxanes described in French Patent Application FR 88-17433 and in particular polydimethylsiloxanes with a stearoyloxy functional group;

h) amphoteric groups such as polydimethylsiloxanes with propylglycolbetaine groups such as the products ABIL E200, B995, BC-1600, BC-1602 from GOLDSCHMIDT or with alkylphosphobetaine groups such as the products PECOSIL SMQ-40 and SPB-1240 from PHOENIX CHEMICAL;

i) bisulfite groups;

j) hydroxyacylamino groups, such as the polydimethylsiloxanes with a hydroxyacylaminopropyl group which are described in Application EP 342 834. There may be mentioned, for example, the product Q2-8413 from the company DOW CORNING;

k) carboxylic acid groups or salts thereof such as the products marketed by BASF under the name DENSODRIN OF or by the company WACKER under the name MS 642 oil;

l) sulfonic groups;

m) sulfate or thiosulfate groups such as the polydimethylsiloxanes with α,ω-thiosulfate groups such as the products ABIL S255, S32 and S201 from GOLDSCHMIDT.

The silicones which are particularly preferred in accordance with the invention are:

polydimethylsiloxanes with trimethylsilyl end groups such as the oils having a viscosity of between 0.2 and 2.5 m²/s at 25° C., such as the oils of the DC200 series from DOW CORNING, in particular that having a viscosity of 60000 cSt, of the SILBIONE 70047 and 47 series and more particularly the oil 70047 V 500000 which are marketed by the company RHODIA CHIMIE, the linear polydimethylsiloxanes with dimethylsilanol end groups such as dimethiconols or polyalkylarylsiloxanes such as the oil SILBIONE 70641 V 200 marketed by the company RHODIA CHIMIE;

the organopolysiloxane resin marketed under the name DOW CORNING 593;

the polysiloxanes with amine-containing groups such as amodimethicones or trimethylsilylamodimethicone.

The synthetic oils are in particular polyolefins, in particular poly-α-olefins, and more particularly:

of the polybutene type, hydrogenated or not, and preferably polyisobutene, hydrogenated or not.

The isobutylene oligomers having a molecular weight of less than 1000 and mixtures thereof with polyisobutylenes having a molecular weight greater than 1000, and preferably between 1000 and 15000, are preferably used.

By way of examples of poly-α-olefins which can be used in the context of the present invention there may be mentioned more particularly the polyisobutenes sold under the name PERMETHYL 99 A, 101 A, 102 A, 104 A (n=16) and 106 A (n=38) by the company PRESPERSE Inc, or alternatively the products sold under the name ARLAMOL HD (n=3) by the company ICI (n denoting the degree of polymerization),

of the polydecene type, hydrogenated or otherwise.

Such products are sold, for example, under the names ETHYLFLO by the company ETHYL CORP., and ARLAMOL PAO by the company ICI.

The animal or vegetable oils are preferably chosen from the group consisting of sunflower oil, corn oil, soybean oil, avocado oil, jojoba oil, gourd oil, grapeseed oil, sesame oil, hazelnut oil, fish oils, glycerol tricaprocaprylate, or vegetable or animal oils of formula R₉COOR₁₀ in which R₉ represents the residue of a higher fatty acid containing from 7 to 29 carbon atoms and R₁₀ represents a linear or branched hydrocarbon chain containing from 3 to 30 carbon atoms, in particular alkyl or alkenyl, for example, Purcellin oil or liquid jojoba wax.

It is also possible to use natural or synthetic essential oils such as, for example, eucalyptus, lavandin, lavender, vetiver, Litsea cubeba, lemon, sandalwood, rosemary, camomile, savory, nutmeg, cinnamon, hissop, caraway, orange, geraniol, cade and bergamot oils.

The vegetable or synthetic waxes are generally solid at room temperature (25°-25° C.). They are insoluble in water, soluble in oils and are capable of forming a waterproof film.

On the definition of waxes, there may be mentioned, for example, P. D. Dorgan, Drug and Cosmetic Industry, December 1983, pp. 30-33.

The vegetable wax or waxes are chosen from Carnauba wax, Candelilla wax, ozokerite, olive wax, rice wax, hydrogenated jojoba wax or absolute flower waxes such as the essential blackcurrant flower wax sold by the company BERTIN (France), cerabellina; marine waxes such as that sold by the company SOPHIM under the reference M82.

The esters which may be used according to the invention are chosen in particular from esters of saturated or unsaturated, linear or branched C₁₀-C₃₀ aliphatic mono-, di- and tricarboxylic acids and of saturated or unsaturated, linear or branched C₁-C₈ aliphatic alcohols or polyols, esters of saturated or unsaturated, linear or branched C₂-C₈ aliphatic mono-, di- and tricarboxylic acids and of saturated or unsaturated, linear or branched C₁₀-C₃₀ aliphatic alcohols or polyols.

Among the esters of the invention, there may be mentioned cetyl lactate; C₁₂-C₁₅ alkyl lactate; isostearyl lactate; lauryl lactate; linoleyl lactate; oleyl lactate; ethyl and isopropyl palmitates, C₁-C₅ alkyl myristates such as isopropyl and butyl myristate, isobutyl stearate; dioctyl malate, hexyl laurate, 2-hexyldecyl laurate.

According to the present invention, ceramide-type compound is understood to mean natural or synthetic ceramides and/or glycoceramides and/or pseudoceramides and/or neoceramides.

Ceramide-type compounds are for example described in the patent applications DE4,424,530; DE4,424,533; DE4,402,929; DE4,420,736; WO95/23807; WO94/07844; EP-A-0,646,572; WO95/16665; FR-2,673,179; EP-A-0,227,994; WO94/07844; WO94/24097 and WO94/10131 whose teachings are included herein by way of reference.

Ceramide-type compounds which can be used according to the present invention preferably correspond to the general formula (I):

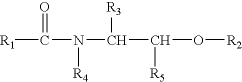

in which:

R₁ denotes:

either a saturated or unsaturated, linear or branched, C₁-C₅₀, preferably C₅-C₅₀, hydrocarbon radical, it being possible for this radical to be substituted with one or more hydroxyl groups optionally esterified by an acid R₇COOH, R₇ being an optionally mono- or polyhydroxylated, linear or branched, saturated or unsaturated, C₁-C₃₅ hydrocarbon radical, it being possible for the hydroxyl(s) of the R₇ radical to be esterified by an optionally mono- or polyhydroxylated, linear or branched, saturated or unsaturated, C₁-C₃₅ fatty acid;

or a radical R″—(NR—CO)—R′, R denotes a hydrogen atom or a mono- or polyhydroxylated, preferably monohydroxylated, Cₗ-C₂₀ hydrocarbon radical, R′ and R″ are hydrocarbon radicals of which the sum of the carbon atoms is between 9 and 30, R′ being a divalent radical;

or a radical R₈—O—CO—(CH₂)ₚ, R₈ denotes a C₁-C₂₀ hydrocarbon radical, p is an integer varying from 1 to 12;

R₂ is chosen from a hydrogen atom, a saccharide-type radical, in particular a (glycosyl)ₙ, (galactosyl)ₘ or sulfogalactosyl radical, a sulfate or phosphate residue, a phosphorylethylamine radical and a phosphorylethylammonium radical, in which n is an integer varying from 1 to 4 and m is an integer varying from 1 to 8;

R₃ denotes a hydrogen atom or a hydroxylated or nonhydroxylated, saturated or unsaturated, C₁-C₃₃ hydrocarbon radical, it being possible for the hydroxyl(s) to be esterified by an inorganic acid or an acid R₇COOH, R₇ having the same meanings as above, it being possible for the hydroxyl(s) to be etherified by a (glycosyl)ₙ, (galactosyl)ₘ, sulfogalactosyl, phosphorylethylamine or phosphorylethylammonium radical, it being also possible for R₃ to be substituted with one or more C₁-C₁₄ alkyl radicals; preferably, R₃ denotes a C₁₅-C₂₆ α-hydroxyalkyl radical, the hydroxyl group being optionally esterified by a C₁₆-C₃₀ α-hydroxy acid;

R₄ denotes a hydrogen atom, a methyl or ethyl radical, an optionally hydroxylated, linear or branched, saturated or unsaturated, C₃-C₅₀ hydrocarbon radical, or a radical —CH₂—CHOH—CH₂—O—R₆ in which R₆ denotes a C₁₀-C₂₆ hydrocarbon radical or a radical R₈—O—CO—(CH₂)ₚ, R₈ denotes a C₁-C₂₀ hydrocarbon radical, p is an integer varying from 1 to 12;

R₅ denotes a hydrogen atom or an optionally mono- or polyhydroxylated, linear or branched, saturated or unsaturated, C₁-C₃₀ hydrocarbon radical, it being possible for the hydroxyl(s) to be etherified by a (glycosyl)ₙ, (galactosyl)ₘ, sulfogalactosyl, phosphorylethylamine or phosphorylethylammonium radical;

with the proviso that when R₃ and R₅ denote hydrogen or when R₃ denotes hydrogen and R₅ denotes methyl, then R₄ does not denote a hydrogen atom, or a methyl or ethyl radical.

Among the compounds of formula (I), the ceramides and/or glycoceramides whose structure is described by DOWNING in Journal of Lipid Research Vol. 35, 2060-2068, 1994, or those described in French patent application FR-2,673,179, whose teachings are included herein by way of reference, are preferred.

The ceramide-type compounds which are more particularly preferred according to the invention are the compounds of formula (I) for which R₁ denotes a saturated or unsaturated alkyl derived from optionally hydroxylated C₁₄-C₂₂ fatty acids; R₂ denotes a hydrogen atom; and R₃ denotes an optionally hydroxylated linear C₁₁₋₁₇, preferably C₁₃₋₁₅, radical.

Such compounds are for example:

2-(N-linoleoylamino)-1,3-octadecanediol,

2-(N-oleoylamino)-1,3-octadecanediol,

2-(N-palmitoylamino)-1,3-octadecanediol,

2-(N-stearoylamino)-1,3-octadecanediol,

2-(N-behenoylamino)-1,3-octadecanediol,

2-[N-(2-hydroxypalmitoyl)amino]-1,3-octadecanediol,

2-(N-stearoylamino)-1,3,4-octadecanetriol and in particular N-stearoylphytosphingosine,

2-(N-palmitoylamino)-1,3-hexadecanediol or mixtures of these compounds.

Specific mixtures, such as, for example, mixtures of ceramide(s) 2 and ceramide(s) 5 according to the DOWNING classification, can also be used.

It is also possible to use the compounds of formula (I) for which R₁ denotes a saturated or unsaturated alkyl radical derived from C₁₂-C₂₂ fatty acids; R₂ denotes a galactosyl or sulfogalactosyl radical; and R₃ denotes a saturated or unsaturated C₁₂-C₂₂ hydrocarbon radical and preferably a group —CH═CH— (CH₂)₁₂—CH₃.

By way of example, there may be mentioned the product consisting of a mixture of glycoceramides, sold under the tradename GLYCOCER by the company WAITAKI INTERNATIONAL BIOSCIENCES.

It is also possible to use the compounds of formula (I) described in patent applications EP-A-0,227,994, EP-A-0,647,617, EP-A-0,736,522 and WO94/07844.

Such compounds are, for example, QUESTAMIDE H (bis(N-hydroxyethyl-N-cetyl)malonamide) sold by the company QUEST, and N-(2-hydroxyethyl)-N-(3-cetyloxy-2-hydroxypropyl)amide of cetylic acid.

It is also possible to use the N-docosanoyl-N-methyl-D-glucamine described in patent application WO94/24097.

The concentration of water-insoluble conditioning agents may vary between 0.0001 and 20% by weight approximately relative to the total weight of the composition and preferably between 0.001 and 10% approximately and still more preferably between 0.005 and 3% by weight.

According to a preferred embodiment, the composition comprises, in addition, at least one cationic polymer.

Still more generally, for the purposes of the present invention, the expression “cationic polymer” denotes any polymer containing cationic groups and/or groups ionizable into cationic groups.

The cationic polymers which may be used in accordance with the present invention may be chosen from any of those already known per se to improve the cosmetic properties of hair treated with detergent compositions, namely in particular those described in Patent Application EP-A-0 337 354 and in French Patent Applications FR-A-2 270 846, 2 383 660, 2 598 611, 2 470 596 and 2 519 863.

The preferred cationic polymers are chosen from those which contain units comprising primary, secondary, tertiary and/or quaternary amine groups which may either form part of the principal polymer chain, or which may be carried by a side substituent directly linked thereto.

The cationic polymers used generally have a number-average molecular mass of between 500 and 5×10⁶ approximately, and preferably of between 10³ and 3×10⁶ approximately.

Among the cationic polymers, there may be mentioned more particularly the polymers of the polyamine, polyaminoamide and quaternary polyammonium type. They are known products.

The polymers of the polyamine, polyaminoamide and quaternary polyammonium type which can be used in accordance with the present invention, which may be especially mentioned, are those described in French Patents No. 2,505,348 or 2,542,997. Among these polymers, there may be mentioned:

(1) the homopolymers or copolymers derived from acrylic or methacrylic esters or amides and comprising at least one of the units of the following formulae:

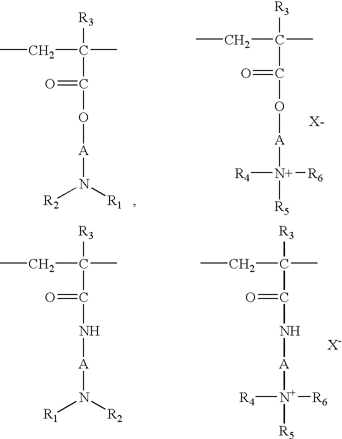

in which:

R₃, which are identical or different, denote a hydrogen atom or a CH₃ radical;

A, which are identical or different, represent a linear or branched alkyl group of 1 to 6 carbon atoms, preferably 2 or 3 carbon atoms or a hydroxyalkyl group of 1 to 4 carbon atoms;

R₄, R₅, R₆, which are identical or different, represent an alkyl group having from 1 to 18 carbon atoms or a benzyl radical and preferably an alkyl group having from 1 to 6 carbon atoms;

R₁ and R₂, which are identical or different, represent hydrogen or an alkyl group having from 1 to 6 carbon atoms and preferably methyl or ethyl;

X denotes an anion derived from an inorganic or organic acid such as a methosulfate anion or a halide such as chloride or bromide.

The copolymers of the family (1) may contain, in addition, one or more units derived from comonomers which may be chosen from the family of acrylamides, methacrylamides, diacetone acrylamides, acrylamides and methacrylamides substituted on the nitrogen with lower (C₁-C₄)alkyls, acrylic or methacrylic acids or esters thereof, vinyllactams such as vinylpyrrolidone or vinylcaprolactam, vinyl esters.

Thus, among these copolymers of the family (1), there may be mentioned:

the copolymers of acrylamide and dimethylaminoethyl methacrylate quaternized with dimethyl sulfate or with a dimethyl halide such as that sold under the name HERCOFLOC by the company HERCULES,

the copolymers of acrylamide and methacryloyloxyethyltrimethylammonium chloride described, for example, in Patent Application EP-A-080976 and sold under the name BINA QUAT P 100 by the company CIBA GEIGY,

the copolymer of acrylamide and methacryloyloxyethyltrimethylammonium methosulfate sold under the name RETEN by the company HERCULES,

the vinylpyrrolidone/dialkylaminoalkyl acrylate or methacrylate copolymers, quaternized or otherwise, such as the products sold under the name “GAFQUAT” by the company ISP such as for example “GAFQUAT 734” or “GAFQUAT 755” or alternatively the products called “COPOLYMER 845, 958 and 937”. These polymers are described in detail in French Patents 2,077,143 and 2,393,573,

the dimethylaminoethyl methacrylate/vinylcaprolactam/vinylpyrrolidone terpolymers such as the product sold under the name GAFFIX VC 713 by the company ISP,

the vinylpyrrolidone/methacrylamidopropyldimethylamine copolymers marketed in particular under the name STYLEZE CC 10 by ISP,

and the quaternized vinylpyrrolidone/dimethylaminopropyl methacrylamide copolymers such as the product sold under the name “GAFQUAT HS 100” by the company ISP.

(2) The cellulose ether derivatives comprising quaternary ammonium groups, described in French Patent 1,492,597, and in particular the polymers marketed under the names “JR” (JR 400, JR 125, JR 30M) or “LR” (LR 400, LR 30M) by the company Union Carbide Corporation. These polymers are also defined in the CTFA dictionary as hydroxyethyl cellulose quaternary ammoniums which have reacted with an epoxide substituted by a trimethylammonium group.

(3) Cationic cellulose derivatives such as cellulose copolymers or cellulose derivatives grafted with a quaternary ammonium water-soluble monomer, and described especially in U.S. Pat. No. 4,131,576, such as hydroxyalkyl celluloses like hydroxymethyl, hydroxyethyl or hydroxypropyl celluloses grafted especially with a methacryloylethyltrimethylammonium, methacrylamidopropyltrimethylammonium or dimethyldiallylammonium salt.

The commercialized products corresponding to this definition are more particularly the products sold under the name “Celquat® L 200” and “Celquat® H 100” by the company National Starch.

(4) The cationic polysaccharides described more particularly in U.S. Pat. Nos. 3,589,578 and 4,031,307 such as guar gums containing cationic trialkylammonium groups. Guar gums modified with a 2,3-epoxypropyltrimethylammonium salt (e.g. chloride) are for example used.

Such products are marketed in particular under the trade names JAGUAR® C13 S, JAGUAR® C 15, JAGUAR® C 17 or JAGUAR® C162 by the company RHODIA CHIMIE.

(5) Polymers consisting of piperazinyl units and of alkylene or hydroxyalkylene divalent radicals with straight or branched chains, optionally interrupted by oxygen, sulfur or nitrogen atoms or by aromatic or heterocyclic rings, as well as the oxidation and/or quaternization products of these polymers. Such polymers are described especially in French patents 2,162,025 and 2,280,361;

(6) Water-soluble polyaminoamides prepared in particular by polycondensation of an acid compound with a polyamine; these polyaminoamides may be crosslinked with an epihalohydrin, a diepoxide, a dianhydride, an unsaturated dianhydride, a diunsaturated derivative, a bishalohydrin, a bisazetidinium, a bishaloacyldiamine, an alkylbishalide or else with an oligomer resulting from the reaction of a difunctional compound which is reactive toward a bishalohydrin, a bisazetidinium, a bishaloacyldiamine, an alkylbishalide, an epihalohydrin, a diepoxide or a diunsaturated derivative; the crosslinking agent being employed in proportions ranging from 0.025 to 0.35 mol per amine group of the polyaminoamide; these polyaminoamides may be alkylated or, if they include one or more tertiary amine functional groups, quaternized. Such polymers are described especially in French Patents 2,252,840 and 2,368,508;

(7) Polyaminoamide derivatives resulting from the condensation of polyalkylenepolyamines with polycarboxylic acids, followed by an alkylation with difunctional agents. There may be mentioned, for example, the adipic acid-dialkylaminohydroxy -alkyldialkylenetriamine polymers in which the alkyl radical contains from 1 to 4 carbon atoms and preferably denotes methyl, ethyl or propyl. Such polymers are described especially in French Patent 1,583,363.

Among these derivatives there may be mentioned more particularly the adipic acid/dimethylaminohydroxypropyl/diethylenetriamine polymers sold under the name “Cartaretine F, F4 or F8” by the company Sandoz.

(8) Polymers obtained by reaction of a polyalkylenepolyamine containing two primary amine groups and at least one secondary amine group with a dicarboxylic acid chosen from diglycolic acid and saturated aliphatic dicarboxylic acids containing from 3 to 8 carbon atoms. The molar ratio of the polyalkylenepolyamine to the dicarboxylic acid being between 0.8:1 and 1.4:1; the polyaminoamide resulting therefrom being made to react with epichlorohydrin in a molar ratio of epichlorohydrin relative to the secondary amine group of the polyaminoamide of between 0.5:1 and 1.8:1. Such polymers are described especially in American patents U.S. Pat. Nos. 3,227,615 and 2,961,347.

Polymers of this type are marketed in particular under the name “Hercosett 57” by the company Hercules Inc. or else under the name of “PD 170” or “Delsette 101” by the company Hercules in the case of the copolymer of adipic acid/epoxypropyl/diethylenetriamine.

(9) Cyclopolymers of alkyldiallylamine or of dialkyldiallylammonium, such as the homopolymers or copolymers comprising, as main constituent of the chain, units corresponding to the formulae (Va) or (Vb):

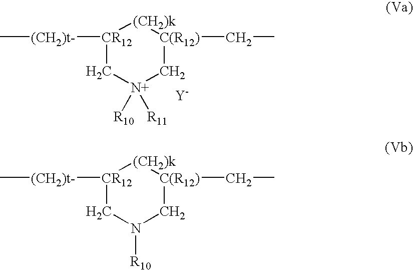

in which formulae k and t are equal to 0 or 1, the sum k+t being equal to 1; R₁₂ denotes a hydrogen atom or a methyl radical; R₁₀ and R₁₁, independently of each other, denote an alkyl group containing from 1 to 22 carbon atoms, a hydroxyalkyl group in which the alkyl group preferably has 1 to 5 carbon atoms, or a lower (C₁-C₄)amidoalkyl group or R₁₀ and R₁₁ may denote, jointly with the nitrogen atom to which they are attached, heterocyclic groups such as piperidinyl or morpholinyl; Y⁻ is an anion such as bromide, chloride, acetate, borate, citrate, tartrate, bisulfate, bisulfite, sulfate or phosphate. These polymers are described especially in French Patent 2,080,759 and in its certificate of addition 2,190,406.

R₁₀ and R₁₁, independently of each other, preferably denote an alkyl group having from 1 to 4 carbon atoms.

Among the polymers defined above there may be mentioned more particularly the dimethyldiallylammonium chloride homopolymer sold under the name “Merquat 100” by the company Calgon (and its homologues of low weight-average molecular masses) and the copolymers of diallyldimethylammonium chloride and acrylamide marketed under the name “MERQUAT 550”.

(10) The quaternary diammonium polymer containing repeat units corresponding to the formula (VI):

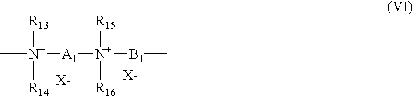

formula (VI) in which:

R₁₃, R₁₄, R₁₅ and R₁₆, which are identical or different, represent aliphatic, alicyclic or arylaliphatic radicals containing from 1 to 20 carbon atoms or lower hydroxyalkyl aliphatic radicals, or else R₁₃, R₁₄, R₁₅ and R₁₆, together or separately, form, with the nitrogen atoms to which they are attached, heterocyclic rings optionally containing a second heteroatom other than nitrogen, or else R₁₃, R₁₄, R₁₅ and R₁₆ denote a linear or branched C₁-C₆ alkyl radical substituted by a nitrile, ester, acyl, amide or —CO—O—R₁₇-D or —CO—NH—R₁₇-D group where R₁₇ is an alkylene and D a quaternary ammonium group;

A₁ and B₁ represent polymethylene groups containing from 2 to 20 carbon atoms which may be linear or branched, saturated or unsaturated and which may contain, bonded to or inserted into the main chain, one or more aromatic rings, or one or more oxygen or sulphur atoms or sulfoxide, sulfone, disulfide, amino, alkylamino, hydroxyl, quaternary ammonium, ureido, amide or ester groups, and

X⁻ denotes an anion derived from an inorganic or organic acid;

A₁, R₁₃ and R₁₅, with the two nitrogen atoms to which they are attached, may form a piperazine ring; in addition if A₁ denotes a saturated or unsaturated, linear or branched alkylene or hydroxyalkylene radical, B₁ may also denote a group (CH₂)ₙ—CO-D-OC—(CH₂)ₙ—

in which D denotes:

a) a glycol residue of formula: —O—Z—O—, where Z denotes a linear or branched hydrocarbon radical or a group corresponding to one of the following formulae:

—(CH₂—CH₂—O)ₓ—CH₂—CH₂

—[CH₂—CH(CH₃)—O]_{y}—CH₂—CH(CH₃)—

where x and y denote an integer from 1 to 4, representing a defined and unique degree of polymerization or any number from 1 to 4 representing a mean degree of polymerization;

b) a disecondary diamine residue such as a piperazine derivative;

c) a diprimary diamine residue of formula: —NH—Y—NH—, where Y denotes a linear or branched hydrocarbon radical or else the divalent radical

—CH₂—CH₂—S—S—CH₂—CH₂—;

d) a ureylene group of formula: —NH—CO—NH—; n varies from 1 to 6

X⁻ is preferably an anion such as chloride or bromide.

These polymers have a number-average molecular mass which is generally between 1000 and 100000.

Polymers of this type are described especially in French Patents 2,320,330, 2,270,846, 2,316,271, 2,336,434 and 2,413,907 and U.S. Pat. Nos. 2,273,780, 2,375,853, 2,388,614, 2,454,547, 3,206,462, 2,261,002, 2,271,378, 3,874,870, 4,001,432, 3,929,990, 3,966,904, 4,005,193, 4,025,617, 4,025,627, 4,025,653, 4,026,945 and 4,027,020.

It is possible to use more particularly the polymers which consist of repeat units corresponding to the formula:

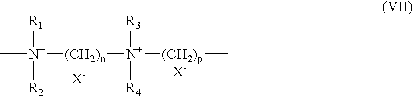

in which R₁, R₂, R₃ and R₄, which are identical or different, denote an alkyl or hydroxyalkyl radical having from 1 to 4 carbon atoms approximately, n and p are integers varying from 2 to 20 approximately and X⁻ is an anion derived from an inorganic or organic acid.

An especially preferred compound of formula (VII) is that for which R₁, R₂, R₃ and R₄ represent a methyl radical and n=3, p=6 and X=Cl, called Hexadimethrine chloride according to the INCI nomenclature (CTFA).

(11) quaternary polyammonium polymers consisting of units of formula (VIII):

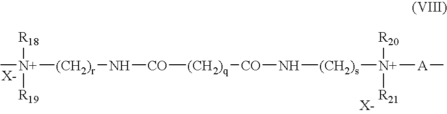

in which formula:

R₁₈, R₁₉, R₂₀ and R₂₁, which are identical or different, represent a hydrogen atom or a methyl, ethyl, propyl, β-hydroxyethyl, β-hydroxypropyl or —CH₂CH₂ (OCH₂CH₂)ₚOH radical,

where p is equal to 0 or to an integer between 1 and 6, provided that R₁₈, R₁₉, R₂₀ and R₂₁ do not simultaneously represent a hydrogen atom,

r and s, which are identical or different, are integers between 1 and 6,

q is equal to 0 or to an integer between 1 and 34,

X⁻ denotes an anion such as a halide,

A denotes a radical of a dihalide or preferably represents —CH₂—CH₂—O—CH₂—CH₂—.

Such compounds are described especially in Patent Application EP-A-122 324.

Among these there may be mentioned, for example, the products “Mirapol® A 15”, “Mirapol® AD1”, “Mirapol® AZ1” and “Mirapol® 175”, sold by the company Miranol.

(12) Quaternary vinylpyrrolidone and vinylimidazole polymers such as, for example, the products marketed under the names Luviquat® FC 905, FC 550 and FC 370 by the company B.A.S.F.

(13) Polyamines like the Polyquart® H sold by COGNIS, referred to under the name of “POLYETHYLENE GLYCOL (15) TALLOW POLYAMINE” in the CTFA dictionary.

(14) The crosslinked polymers of methacryloyloxy(C₁-C₄ alkyl)tri(C₁-C₄ alkyl)ammonium salts such as the polymers obtained by homopolymerization of dimethylaminoethyl methacrylate quaternized with methyl chloride, or by copolymerization of acrylamide with dimethylaminoethyl methacrylate quaternized with methyl chloride, the homo- or copolymerization being followed by crosslinking with a compound containing olefinic unsaturation, in particular methylenebisacrylamide. More particularly, it is possible to employ a crosslinked acrylamide/methacryloyloxyethyltrimethylammonium chloride copolymer (20/80 by weight) in the form of a dispersion containing 50% by weight of said copolymer in mineral oil. This dispersion is marketed under the name of “SALCARE® SC 92” by the company ALLIED COLLOIDS. It is also possible to employ a crosslinked methacryloyloxyethyltrimethylammonium chloride homopolymer containing approximately 50% by weight of the homopolymer in mineral oil or in a liquid ester. These dispersions are marketed under the names of “SALCARE® SC 95” and “SALCARE® SC 96” by the company ALLIED COLLOIDS.

Other cationic polymers that may be employed within the scope of the invention are cationic proteins or hydrolysates of cationic proteins, polyalkyleneimines, in particular polyethyleneimines, polymers containing vinylpyridine or vinylpyridinium units, condensates of polyamines and of epichlorohydrin, quaternary polyureylenes and chitin derivatives.

Among all the cationic polymers capable of being used within the scope of the present invention, it is preferable to use quaternary cellulose ether derivatives such as the products sold under the name “JR 400” by the company UNION CARBIDE CORPORATION, cationic cyclopolymers, in particular the homopolymers or copolymers of dimethyl-diallylammonium chloride, sold under the names “MERQUAT 100”, “MERQUAT 550” and “MERQUAT S” by the company CALGON, cationic polysaccharides such as guar gums modified by a salt of 2,3-epoxypropyltrimethylammonium, quaternary polymers of vinylpyrrolidone and of vinylimidazole and mixtures thereof.

According to the invention, the cationic polymer(s) may represent from 0.001% to 10% by weight, preferably from 0.005% to 5% by weight, and more particularly from 0.01 to 3% by weight relative to the total weight of the final composition.

The cosmetically acceptable aqueous medium may consist solely of water or of a mixture of water and a cosmetically acceptable solvent such as a C₁-C₄ lower alcohol, such as ethanol, isopropanol, tert-butanol, n-butanol; alkylene glycols such as propylene glycol, glycol ethers.

The detergent compositions according to the invention have a final pH which is generally between 3 and 10. Preferably, this pH is between 4 and 8. The pH can be conventionally adjusted to the desired value by adding a base (an organic or inorganic base) to the composition, for example aqueous ammonia or a primary, secondary or tertiary poly(amine) such as monoethanolamine, diethanolamine, triethanolamine, isopropanolamine or 1,3-propanediamine, or alternatively by adding an acid, preferably a carboxylic acid such as, for example, citric acid.

The compositions in accordance with the invention may contain, in addition to the combination defined above, viscosity-regulating agents such as electrolytes, or thickeners (associative or nonassociative thickeners). There may be mentioned in particular sodium chloride, sodium xylenesulfonate, scleroglucans, xanthan gums, fatty acid alkanolamides, alkylethercarboxylic acid alkanolamides which are optionally oxyethylenated with up to 5 mol of ethylene oxide such as the product marketed under the name “AMINOL A15” by the company CHEM Y, crosslinked polyacrylic acids and crosslinked acrylic acid/C₁₀-C₃₀ alkyl acrylate copolymers. These viscosity-regulating agents are used in the compositions according to the invention in proportions which may be up to 10% by weight relative to the total weight of the composition.

The compositions according to the invention may also preferably contain up to 5% of pearlescent or opacifying agents well known in the state of the art, such as for example C₁₆ higher fatty alcohols, fatty chain-containing acylated derivatives such as ethylene glycol or polyethylene glycol monostearates or distearates, fatty chain-containing ethers such as, for example, distearyl ether or 1-(hexdecyloxy)-2-octadecanol.

The compositions in accordance with the invention may optionally contain, in addition, at least one additive chosen from foam synergists such as C₁₀-C₁₈ 1,2-alkanediols or fatty alkanolamides derived from mono- or diethanolamine, silicone or nonsilicone sunscreens, cationic or nonionic surfactants, anionic or nonionic polymers, amphoteric polymers different from those of the invention, proteins, protein hydrolysates, hydroxy acids, vitamins, provitamins such as panthenol, and any other additive conventionally used in the cosmetic field which does not affect the properties of the compositions according to the invention.

Of course, persons skilled in the art will be careful to choose this or these optional additional compounds and/or their quantities such that the advantageous properties intrinsically attached to the combination in accordance with the invention are not, or not substantially, impaired by the additions envisaged.

These additives are present in the composition according to the invention in proportions which may range from 0.00001 to 20% by weight relative to the total weight of the composition. The precise quantity of each additive is easily determined by persons skilled in the art according to its nature and its function.

According to the invention, the nonionic and/or cationic surfactants are generally present at a concentration ranging from 0.01% to 30% by weight, preferably from 0.1% to 20% by weight, and still more preferably from 0.5% to 15% by weight, relative to the total weight of the composition.

The total quantity of surfactants is generally in a concentration ranging from 3% to 60% by weight, but better still from 4% to 30% by weight, relative to the total weight of the composition.

Preferably, the composition does not comprise the combination of the following surfactants: sodium lauryl sulfate, sodium lauryl ether sulfate, cocamidopropylbetaine, sodium N-cocoyl L-Glutamate (INCI name 1997), PEG-150 pentaerythrityl tetrastearate (INCI name 1997), PEG-6 caprylic/capric glyceride (INCI name 1997), cocamide MEA (INCI name 1997), and PEG-60 almond glyceride (INCI name 1997).

These compositions may be provided in the form of liquids thickened to a greater or lesser degree, creams, gels, and they are mainly suitable for the washing and care of keratinous materials, in particular the hair and the skin, and still more particularly the hair.

The compositions in accordance with the invention may be used more particularly for washing or treating keratinous materials such as the hair, the skin, the eyelashes, the eyebrows, the nails, the lips, the scalp and more particularly the hair.

When the compositions in accordance with the invention are used as conventional shampoos, they are simply applied to wet hair and the foam generated by massaging or rubbing with the hands is then removed, after an optional leave-in time, by rinsing with water, it being possible for the operation to be repeated once or several times.

The subject of the invention is also a method for washing and conditioning keratinous materials such as in particular the hair which consists in applying to said wet materials an effective quantity of a composition as defined above, and then in rinsing with water after an optional leave-in time.

The compositions according to the invention are preferably used as shampoos for washing and conditioning hair and they are applied in this case to wet hair in effective quantities to wash it, this application being followed by rinsing with water.

The compositions in accordance with the invention can also be used as shower gels for washing and conditioning the hair and/or the skin, in which case they are applied to the wet hair and/or skin and are rinsed off after application.

The compositions of the invention may also be provided in the form of a leave-in or rinse-out conditioner, of compositions for permanent waving, hair straightening, dyeing or bleaching, or alternatively in the form of rinse-out compositions, to be applied before or after dyeing, bleaching, permanent waving or hair straightening or alternatively between the two stages of a permanent waving or of a hair straightening.

When the composition is provided in the form of a conditioner to be optionally rinsed out, it advantageously contains a cationic surfactant, its concentration generally ranging from 0.1 to 10% by weight, and preferably from 0.2 to 5% by weight relative to the total weight of the composition.

The compositions of the invention may also be provided in the form of washing compositions for the skin, and in particular in the form of bath or shower solutions or gels or of makeup-removing products.

The compositions according to the invention may also be provided in the form of aqueous or aqueous-alcoholic lotions for skin and/or hair care.

The cosmetic compositions according to the invention may be provided in the form of a gel, milk, cream, emulsion, thickened lotion or mousse and may be used for the skin, the nails, the eyelashes, the lips and more particularly the hair.

The compositions may be packaged in various forms, in particular in vaporizers, pump dispensers or in aerosol containers so as to ensure application of the composition as a spray or as a mousse. Such packaging forms are recommended, for example, when it is desired to obtain a spray, a lacquer or a mousse for treating hair.

Concrete, but not at all limiting, examples illustrating the invention will now be given.

### EXAMPLES 1 TO 5

The conditioners in accordance with the invention were prepared which have the following compositions:

| | 1 | 2 | 3 | 4 | 5 |
|---|---|---|---|---|---|
| Sodium lauryl ether | 8 g AS | 14 g AS | 15.5 g AS | 15 g AS | 9.8 g AS |
| sulfate 2.2 EO at 70% | | | | | |
| AS (TEXAPON NSW from | | | | | |
| COGNIS) | | | | | |
| Cocoylbetaine in | 2 g AS | — | 5 g AS | 5 g AS | 1.6 g AS |
| aqueous solution at 30 g | | | | | |
| AS (DEHYTON AB 30 from | | | | | |
| COGNIS) | | | | | |
| Sodium N-cocoylamido- | — | 3 g AS | — | — | — |
| ethyl-N-ethoxycarboxy- | | | | | |
| methyl glycinate | | | | | |
| (MIRANOL C2M CONC NP | | | | | |
| from RHODIA CHIMIE) | | | | | |
| Lauryl ethercarboxylic | — | — | — | — | 5.6 g AS |
| acid (AKYPO RLM 45 from | | | | | |
| CHEM Y) | | | | | |
| Polydimethylsiloxane of | 0.5 g | 2.7 g | — | — | — |
| viscosity 60 000 cSt | | | | | |
| (DC200 Fluid from DOW | | | | | |
| CORNING) | | | | | |
| Isopropyl myristate | — | — | 2 g | — | — |
| Isohexadecane | — | — | | 1.5 g | — |
| Liquid jojoba wax | — | — | | | 2 g |
| Chloride of hydroxy- | 1 g AS | — | — | — | 0.2 g AS |
| propyltrimethylammonium | | | | | |
| guar modified with | | | | | |
| carboxymethyl (National | | | | | |
| Starch) | | | | | |
| cationic DS: 0.62 | | | | | |
| anionic DS: 0.3 | | | | | |
| Chloride of hydroxy- | — | 0.2 g AS | — | 0.5 g AS | — |
| propyltrimethylammonium | | | | | |
| guar modified with | | | | | |
| carboxymethyl (National | | | | | |
| Starch) | | | | | |
| cationic DS: 0.28 | | | | | |
| anionic DS: 0.2 | | | | | |
| Chloride of hydroxy- | — | — | 0.4 g AS | — | — |
| propyltrimethylammonium | | | | | |
| guar modified with | | | | | |
| carboxymethyl (National | | | | | |
| Starch) | | | | | |
| cationic DS: 0.11 | | | | | |
| anionic DS: 0.33 | | | | | |
| Sodium chloride | | | 4 g | 4 g | |
| Glycol distearate | — | 2.5 g | 2 g | — | 2 g |
| Crosslinked polyacrylic | — | — | — | — | 0.25 g AS |
| acid (CARBOPOL 980 from | | | | | |
| NOVEON) | | | | | |
| water qs | 100 g | 100 g | 100 g | 100 g | 100 g |

A shampoo is performed by applying about 12 g of the composition to previously wet hair. The shampoo is caused to lather and then it is abundantly rinsed out with water.

The composition has a texture which is thick and very melting during application to wet hair. Its rinsability is good. The wet hair is not charged and is easy to shape.

A panel of experts found that the compositions in accordance with the invention confer on the hair, after rinsing, a remarkable treating effect which manifests itself in particular by ease of disentanglement and styling, and remarkable sleekness and softness of the hair.

1. A detergent and conditioning composition, characterized in that it comprises, in a cosmetically acceptable medium, at least one anionic surfactant, at least one amphoteric surfactant, at least one amphoteric polysaccharide chosen from celluloses, inulins and guar gums, and at least one water-insoluble conditioning agent chosen from:
A) synthetic oils,
B) silicones chosen from:
(i) polyalkylsiloxanes, polyarylsiloxanes, polyalkylarylsiloxanes, silicone resins and gums, which are linear, branched or cyclic, crosslinked or noncrosslinked, having a viscosity greater than or equal to 1000 mm²/s (1000 cSt),
(ii) polysiloxanes, containing in their general structure one or more organofunctional groups,
C) animal or vegetable oils,
D) waxes,
E) esters chosen from esters of saturated or unsaturated, linear or branched C₁₀-C₃₀ aliphatic mono-, di- and tricarboxylic acids and of saturated or unsaturated, linear or branched C₁-C₈ aliphatic alcohols or polyols, esters of saturated or unsaturated, linear or branched C₂-C₈ aliphatic mono-, di- and tricarboxylic acids and of saturated or unsaturated, linear or branched C₁₀-C₃₀ aliphatic alcohols or polyols,
F) compounds of the ceramide type.

2. The composition as claimed in claim 1, characterized in that said anionic surfactant(s) are present in an amount of 2 to 50% by weight, preferably 3 to 30% by weight, relative to the total weight of the composition.

3. The composition as claimed in any one of the preceding claims, characterized in that said amphoteric surfactant(s) are present in an amount of 1 to 50% by weight, preferably 1 to 20% by weight, relative to the total weight of the composition.

4. The composition as claimed in any one of the preceding claims, characterized in that the amphoteric surfactant/anionic surfactant weight ratio is between 0.2 and 10, more particularly between 0.25 and 5, and still more particularly between 0.3 and 3.

5. The composition as claimed in any one of the preceding claims, characterized in that said anionic surfactant is chosen from sodium, triethanolamine or ammonium (C₁₂-C₁₄)alkyl sulfates, oxyethylenated sodium, triethanolamine or ammonium (C₁₂-C₁₄)alkyl ether sulfates containing 2.2 mol of ethylene oxide, from sodium, triethanolamine or ammonium (C₁₂-C₁₄)alkylamidosulfates, sodium cocoyl isethionate and sodium (C₁₄-C₁₆)alphaolefin sulfonate.

6. The composition as claimed in any one of the preceding claims, characterized in that said amphoteric surfactant is chosen from derivatives of aliphatic secondary or tertiary amines in which the aliphatic radical is a linear or branched chain containing 8 to 22 carbon atoms and containing at least one anionic group, (C₈-C₂₀)alkylbetaines, sulfobetaines, (C₈-C₂₀) alkylamido (C₁-C₆) alkylbetaines or (C₈-C₂₀) alkylamido (C₁-C₆)alkylsulfobetaines.

7. The composition as claimed in any one of the preceding claims, characterized in that said polysaccharide is chosen from
polysaccharides grafted with units A and B where A denotes a cationic unit derived from a monomeric or polymeric group containing at least one nitrogen atom belonging to a primary, secondary, tertiary or quaternary amine functional group, and B denotes an anionic unit derived from a monomeric or polymeric group containing one or more carboxylic acid, phosphoric acid, phosphonic acid, sulfate or sulfonic acid functional groups;
polysaccharides grafted with one or more units C, where C denotes a unit derived from a monomeric or polymeric group containing at least one zwitterionic group of carboxybetaines or sulfobetaines;
polysaccharides grafted with one or more units D, where D denotes a unit derived from a monomeric or polymeric group containing at least one anionic group derived from a monomeric or polymeric group containing one or more carboxylic acid, phosphoric acid, phosphonic acid, sulfate or sulfonic acid functional groups and at least one cationic group containing a primary, secondary, tertiary or quaternary amine functional group.

8. The composition as claimed in any one of the preceding claims, characterized in that the polysaccharide has a total degree of substitution between 0.01 and 3, and preferably between 0.1 and 2.5.

9. The composition as claimed in any one of the preceding claims, characterized in that the polysaccharide has a cationic degree of substitution to anionic degree of substitution ratio between 0.01 and 100, and preferably between 0.02 and 50.

10. The composition as claimed in any one of the preceding claims, characterized in that the polysaccharide is chosen from chlorides of hydroxypropyltrimethylammonium guar which are modified with a carboxymethylpropane group.

11. The composition as claimed in any one of the preceding claims, characterized in that said polysaccharide is present in a concentration between 0.001 and 10%, and still more preferably between 0.005 and 3% by weight.

12. The composition as claimed in any one of the preceding claims, characterized in that:
(a) the polyalkylsiloxanes are chosen from:
polydimethylsiloxanes having trimethylsilyl end groups;
polydimethylsiloxanes having dimethylsilanol end groups;
poly(C₁-C₂₀)alkylsiloxanes;
(b) the polyalkylarylsiloxanes are chosen from:
linear and/or branched polydimethylmethylphenylsiloxanes and polydimethyldiphenylsiloxanes having a viscosity between 1×10⁻⁵ and 5×10-2 m²/s at 25° C.;
(c) the silicone gums are chosen from polydiorganosiloxanes having number-average molecular masses between 200000 and 1000000, used alone or in the form of a mixture in a solvent;
(d) the resins are chosen from resins consisting of units: R₃SiO_{1/2}, R₂SiO_{2/2}, RSiO_{3/2}, SiO_{4/2} in which R represents a hydrocarbon group having from 1 to 16 carbon atoms or a phenyl group.

13. The composition as claimed in any one of the preceding claims, characterized in that the organofunctional groups are chosen from:
a) substituted or unsubstituted amine-containing groups;
b) (per)fluorinated groups;
c) thiol groups;
d) carboxylate groups;
e) hydroxylated groups;
f) alkoxylated groups;
g) acyloxyalkyl groups;
h) amphoteric groups;
i) bisulfite groups;
j) hydroxyacylamino groups;
k) carboxylic acid groups;
l) sulfonic groups;
m) sulfate or thiosulfate groups.

14. The composition as claimed in any one of the preceding claims, characterized in that the silicones are chosen from linear polydimethylsiloxanes having trimethylsilyl end groups, linear polydimethylsiloxanes having hydroxydimethylsilyl end groups, silicone resins, amodimethicones or trimethylsilylamodimethicones.

15. The composition as claimed in any one of the preceding claims, characterized in that the synthetic oils are polyolefins of the hydrogenated or nonhydrogenated polybutene type or of the hydrogenated or nonhydrogenated polydecene type.

16. The composition as claimed in any one of the preceding claims, characterized in that the animal or vegetable oils are chosen from the group consisting of sunflower oil, corn oil, soybean oil, avocado oil, jojoba oil, gourd oil, grapeseed oil, sesame oil, hazelnut oil, fish oils, glycerol tricaprocaprylate, or vegetable or animal oils of formula R₉COOR₁₀ in which R₉ represents the residue of a higher fatty acid containing from 7 to 29 carbon atoms and R₁₀ represents a linear or branched hydrocarbon chain containing from 3 to 30 carbon atoms, in particular alkyl or alkenyl, natural or synthetic essential oils such as, for example, eucalyptus, lavandin, lavender, vetiver, Litsea cubeba, lemon, sandalwood, rosemary, camomile, savory, nutmeg, cinnamon, hissop, caraway, orange, geraniol, cade and bergamot oils.

17. The composition as claimed in any one of the preceding claims, characterized in that the vegetable waxes are chosen from Carnauba wax, Candelilla wax, ozokerite, olive wax, rice wax, hydrogenated jojoba wax or absolute flower waxes such as the essential blackcurrant flower wax, marine waxes.

18. The composition as claimed in any one of the preceding claims, characterized in that the ceramide-type compounds correspond to the general formula (I): 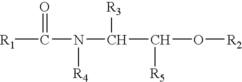
in which:
R₁ denotes:
either a saturated or unsaturated, linear or branched, C₁-C₅₀, preferably C₅-C₅₀, hydrocarbon radical, it being possible for this radical to be substituted with one or more hydroxyl groups optionally esterified by an acid R₇COOH, R₇ being an optionally mono- or polyhydroxylated, linear or branched, saturated or unsaturated, C₁-C₃₅ hydrocarbon radical, it being possible for the hydroxyl(s) of the R₇ radical to be esterified by an optionally mono- or polyhydroxylated, linear or branched, saturated or unsaturated, C₁-C₃₅ fatty acid;
or a radical R″—(NR—CO)—R′, R denotes a hydrogen atom or a mono- or polyhydroxylated, preferably monohydroxylated, C₁-C₂₀ hydrocarbon radical, R′ and R″ are hydrocarbon radicals of which the sum of the carbon atoms is between 9 and 30, R′ being a divalent radical;
or a radical R₈—O—CO—(CH₂)ₚ, R₈ denotes a C₁-C₂₀ hydrocarbon radical, p is an integer varying from 1 to 12;
R₂ is chosen from a hydrogen atom, a saccharide-type radical, in particular a (glycosyl)ₙ, (galactosyl)ₘ or sulfogalactosyl radical, a sulfate or phosphate residue, a phosphorylethylamine radical and a phosphorylethylammonium radical, in which n is an integer varying from 1 to 4 and m is an integer varying from 1 to 8;
R₃ denotes a hydrogen atom or a hydroxylated or nonhydroxylated, saturated or unsaturated, C₁-C₃₃ hydrocarbon radical, it being possible for the hydroxyl(s) to be esterified by an inorganic acid or an acid R₇COOH, R₇ having the same meanings as above, it being possible for the hydroxyl(s) to be etherified by a (glycosyl)ₙ, (galactosyl)ₘ, sulfogalactosyl, phosphorylethylamine or phosphorylethylammonium radical, it being also possible for R₃ to be substituted with one or more C₁-C₁₄ alkyl radicals; preferably, R₃ denotes a C₁₅-C₂₆ a-hydroxyalkyl radical, the hydroxyl group being optionally esterified by a C₁₆-C₃₀ a-hydroxy acid;
R₄ denotes a hydrogen atom, a methyl or ethyl radical, an optionally hydroxylated, linear or branched, saturated or unsaturated, C₃-C₅₀ hydrocarbon radical, or a radical —CH₂—CHOH—CH₂—O—R₆ in which R₆ denotes a C₁₀-C₂₆ hydrocarbon radical or a radical R₈—O—CO—(CH₂)ₚ, R₈ denotes a C₁-C₂₀ hydrocarbon radical, p is an integer varying from 1 to 12;
R₅ denotes a hydrogen atom or an optionally mono- or polyhydroxylated, linear or branched, saturated or unsaturated, C₁-C₃₀ hydrocarbon radical, it being possible for the hydroxyl(s) to be etherified by a (glycosyl)ₙ, (galactosyl)ₘ, sulfogalactosyl, phosphorylethylamine or phosphorylethylammonium radical;
with the proviso that when R₃ and R₅ denote hydrogen or when R₃ denotes hydrogen and R₅ denotes methyl, then R₄ does not denote a hydrogen atom, or a methyl or ethyl radical.

19. The composition as claimed in the preceding claim, characterized in that the ceramide-type compound is chosen from the group consisting of:
2-(N-linoleoylamino)-1,3-octadecanediol,
2-(N-oleoylamino)-1,3-octadecanediol,
2-(N-palmitoylamino)-1,3-octadecanediol,
2-(N-stearoylamino)-1,3-octadecanediol,
2-(N-behenoylamino)-1,3-octadecanediol,
2-[N-(2-hydroxypalmitoyl)amino]-1,3-octadecanediol,
2-(N-stearoylamino)-1,3,4-octadecanetriol,
2-(N-palmitoylamino)-1,3-hexadecanediol,
-bis(N-hydroxyethyl-N-cetyl)malonamide,
N-(2-hydroxyethyl)-N-(3-cetyloxy-2-hydroxypropyl)amide of cetylic acid,
N-docosanoyl-N-methyl-D-glucamine or mixtures of these compounds.

20. The composition as claimed in any one of the preceding claims, characterized in that the insoluble conditioning agents are present in concentrations ranging from 0.0001 to 20% by weight relative to the total weight of the composition, and preferably from 0.001 to 10% by weight, and more preferably between 0.005 and 3% by weight.

21. The composition as claimed in any one of claims 1 to 20, characterized in that it comprises, in addition, at least one cationic polymer.

22. The composition as claimed in claim 21, characterized in that said cationic polymer is chosen from quaternary cellulose ether derivatives, cationic cyclopolymers, cationic polysaccharides, quaternary polymers of vinylpyrrolidone and of vinylimidazole and mixtures thereof.

23. The composition as claimed in claim 22, characterized in that said cyclopolymer is chosen from homopolymers of diallyldimethylammonium chloride and copolymers of diallyldimethylammonium chloride and acrylamide.

24. The composition as claimed in claim 22, characterized in that said quaternary cellulose ether derivatives are chosen from hydroxyethylcelluloses which have reacted with an epoxide substituted with a trimethylammonium group.

25. The composition as claimed in claim 22, characterized in that said cationic polysaccharides are chosen from guar gums modified with a 2,3-epoxypropyltrimethylammonium salt.

26. The composition as claimed in any one of claims 21 to 25, characterized in that the cationic polymer represents from 0.001% to 10% by weight, preferably from 0.005% to 5% by weight, and still more preferably from 0.01% to 3% by weight, of the total weight of the composition.

27. The composition as claimed in any one of claims 1 to 26, characterized in that it comprises, in addition, at least one additive chosen from foam synergists such as C₁₀-C₁₈ 1,2-alkanediols or fatty alkanolamides derived from mono- or diethanolamine, silicone or nonsilicone sunscreens, cationic surfactants, anionic or nonionic or amphoteric polymers, proteins, protein hydrolysates, hydroxy acids, vitamins, provitamins such as panthenol, and any other additive conventionally used in the cosmetic field.

28. The composition as claimed in any one of the preceding claims, characterized in that it comprises, in addition, at least one surfactant chosen from nonionic and cationic surfactants, and mixtures thereof.

29. The composition as claimed in claim 28, characterized in that said nonionic and/or cationic surfactants are present at a concentration ranging from 0.01% to 30% by weight, preferably from 0.1% to 20% by weight.

30. The composition as claimed in any one of claims 1 to 29, characterized in that the total quantity of surfactants is in a concentration ranging from 3% to 60% by weight, and better still from 4% to 30% by weight relative to the total weight of the composition.

31. The composition as claimed in any one of the preceding claims, characterized in that it is provided in the form of a shampoo, a conditioner, a composition for permanent waving, straightening, dyeing or bleaching the hair, a rinse-out composition to be applied between the two stages of permanent waving or hair straightening, and washing compositions for the skin.

32. The use of a composition as defined in any one of claims 1 to 31, as a shampoo for keratinous materials.

33. Method for washing and conditioning keratinous fibers such as hair, consisting in applying to said wet fibers an effective quantity of a composition as defined in any one of the preceding claims, and then in rinsing out with water after an optional leave-in time.
